(19) United States
(12) Patent Application Publication
(10) Pub. No.: US 2009/0265028 A1
(43) Pub. Date: Oct. 22, 2009

(54) Organic Substrate with Asymmetric Thickness for Warp Mitigation

(75) Inventors: Sri M. Sri-Jayantha, Ossining, NY (US); Arun Sharma, New Rochelle, NY (US); Vijayeshwar D. Khanna, Millwood, NY (US); Hien P. Dang, Nanuet, NY (US); David J. Russell, Owego, NY (US); Douglas O. Powell, Endicott, NY (US)

Correspondence Address: Leander F. Aulisio, 320 23rd Street S. #705, Arlington, VA, 22202, US

(73) Assignee: INTERNATIONAL BUSINESS MACHINES CORPORATION, Armonk, NY (US)

(21) Appl. No.: 12/107,064

(22) Filed: Apr. 21, 2008

(51) Int. Cl. G06F 19/00

(52) U.S. Cl. 700/121

(57) ABSTRACT

A process for large scale production of a laminated organic substrate having reduced thermal warp.

The present invention relates to a computerized process for predicting warping of an organic substrate having a die footprint, and adjusting the fabrication process to negate the warp.

### BACKGROUND OF THE INVENTION

The trend in integrated circuit packaging technology is shifting from the ceramic substrate-based interconnection circuit devices to organic substrate-based interconnection circuit devices for single chip modules (SCMs) and multi-chip modules (MCMs) because the organic substrate-based devices are less expensive to process and fabricate. However, the organic substrate useful in the formation of the integrated circuits is thin.

When relatively thinner conventional organic substrate-based interconnection circuit devices are attached to an integrated circuit die, the thinner structures of the devices flex and bend more readily than the thicker ceramic substrate devices because of differences in the coefficients of thermal expansion (CTE) between the materials used in the organic substrate devices and the integrated circuit die or chip, and because of mechanical stresses that occur when the interconnection devices and the chips are attached.

The following references disclose attempts to achieve reduced warp in various substrates. They are included as general interest.

US Patent Application Publication No. 2006/0036401 (Kobayashi et al) and U.S. Pat. No. 7,139,678 (Kobayashi et al) disclose a computer-readable recording medium that stores a computer program for predicting a deformation of a board, wherein the computer program makes a computer execute: the step of dividing the board into a plurality of areas based on wiring information on the board; the step of predicting the deformation of the board based on an equivalent physical property value obtained by grasping a wiring pattern of an area macroscopically and calculating the equivalent physical property value equivalent to a modulus of longitudinal elasticity for each of the plurality of areas of the board and a coefficient of thermal expansion for each of the plurality of areas of the board based on a finite element method for each of the areas of the divided board; and the step of generating results containing information regarding the predicted deformation of the board, wherein the results are used to take measures for preventing deformation from occurring in advance.

U.S. Pat. No. 7,253,504 (Zhai et al) discloses an integrated circuit package including a substrate having a central axis dividing the substrate into an upper half and a lower half. An integrated circuit is coupled to the substrate. A layer is provided within the substrate in the lower half thereof. The layer is configured to resist warpage of the integrated circuit package.

US Patent Application Publication No. 2006/0212155 (Fukuzono et al) and U.S. Pat. No. 7,260,806 (Fukuzono et al) disclose a method and apparatus for aiding the design of a printed wiring board. The method can readily predict thermal warp of the board. A computer executes the steps of dividing an analytical model of a printed wiring board obtained as data into meshes; calculating the displacement of the respective meshes of the printed wiring board; connecting the mesh displacements that were calculated so that the inclination of the borders of the respective meshes becomes equal; and then calculating a displacement using an entire displacement of the printed wiring board which was obtained in the step of connecting the mesh displacements.

US Patent Application Publication No. 2007/0063324 (Mishiro et al) discloses a method of reducing the warp of a substrate. The method comprises bonding a warp reducing member to a substrate with a first bonding material having a melting point lower than that of a second bonding material. The second bonding material electrically connects electronic parts to the substrate. The size of the warp reducing member is substantially the same size as that of each of a plurality of electronic parts. The warp reducing member is bonded on the surface of the substrate opposite to the side where the electronic parts are bonded.

WO 2005081603 discloses a method of producing a multilayered printed circuit board. The method utilizes deviations to determine two transformations for position deviation from grid points of two layers, and combining transformations to process one layer. The method involves determining deviation of an actual position from a desired position for every mark in a first layer. The deviations are used to determine a transformation for position deviation from any grid point of the layer, and another transformation for any position deviation from grid point of a second layer. The two transformations are combined and the first layer is processed under consideration of the combined transformation.

None of the above-referenced patents or applications, taken either separately or in combination, anticipate the present invention as disclosed and claimed as below.

### SUMMARY OF THE INVENTION

An embodiment of the present invention is a simple design process for preparing an organic substrate that has layers of asymmetric thickness. The layout of the substrate with asymmetric thickness prevents future warpage of the relatively thin substrate during high temperature processing steps. In another embodiment, the layer that is adjusted by this process is a front dielectric layer or a bottom dielectric layer on either side of the organic core. A further embodiment is the adjustment of the front or back dielectric layer which is nearest to the core.

A computer-readable recording medium according to still another aspect of the present invention stores a computer program that causes a computer to execute the described process according to the present invention.

The other objects, features, and advantages of the present invention are specifically set forth in the following detailed description of the invention when read in conjunction with the accompanying drawings.

### BRIEF DESCRIPTION OF THE DRAWINGS

FIG. 1 is a schematic representation of a standard laminated organic substrate having a die footprint.

FIG. 2 is a schematic representation of a cross-section of a laminated organic substrate containing a core, circuit layers and dielectric layers.

FIG. 3 is a diagram of warp mechanism of a bare organic substrate having a front layer of high coefficient of thermal expansion (CTE) and a back layer of low coefficient of thermal expansion (CTE).

FIG. 4 is a schematic representation of a cross section of a laminated organic substrate containing a core, circuit layers and dielectric layers; and wherein the thickness of a back dielectric layer has been adjusted.

FIG. 5 is a schematic representation of a cross section of a laminated organic substrate containing a core, circuit layers and dielectric layers; and wherein the thickness of a front dielectric layer has been adjusted.

FIG. 6 is a flow chart of the process of the present invention; wherein the process is an organic substrate design process for large scale fabrication.

FIG. 7 is a Cartesian coordinate representation of warp mitigation based on the process of the present invention.

### DETAILED DESCRIPTION OF THE INVENTION

A laminated substrate is constructed by laminating alternating layers of conductive material and dielectric material on either side of a core layer. The thickness of each layer is substantially the same as the thickness of its corresponding layer on the other side of the core layer. The various layers are positioned in a stack and then pressed together, usually with a dielectric material in a b-stage of curing so that the layers are not fully cured until after pressing. The laminated substrate comprises a core layer and a plurality of copper interconnect layers and resin layers in alternating pattern. Typically, the layers external to the core layer are arranged to be symmetrically disposed with respect to the core layer. In one embodiment, the core layer comprises an organic resin that has a high glass transition temperature. The transition temperature of the core layer is about 200 degrees C. or higher. The core layer provides structural strength to the overall laminated organic substrate. The core layer can have various thicknesses. In one embodiment, the core layer has a thickness of about 400 micrometers.

The copper interconnect layers, also called the circuit layers or the electrical layers, are typically about 15 micrometers thick, except for the layers next to the resinous core layer. The circuit layers next to the resinous core layer, called center layers, are about 21 micrometers or more in thickness. Copper interconnect layers can have some uncertainty in thickness because of the method of deposition of said layers. The organic resin layers, also called the dielectric layers, are about 35 micrometers in thickness. In one embodiment, the organic resin layers are designed to have symmetrical thickness distribution with respect to the plane of symmetry drawn through the central core layer. Because of sometimes complex circuitry below the resin layers, a method to compensate for loss in resin thickness is employed. The method comprises the step of adding a second thin resinous layer, usually on the order of 3-5 micrometers.

Laminated organic substrates useful in the fabrication of electronic modules are preferably about 1 mm. thick and have dimensions of about 55×55 mm. In the future, laminated organic substrates will have larger dimensions to accommodate high performance computer chips. A solder reflow process is employed to attach a silicon die (chip) to the substrate. The process is conducted at a temperature of about 225 degrees C. The die contains microelectronic circuits. In one embodiment, the laminated organic substrate comprises organic resinous materials that are embedded with copper interconnects.

Laminated organic substrates are heated to a temperature of about 200 degrees C. or higher. They are then cooled to room temperature for subsequent assembly steps. Warping of the laminated organic substrates occurs because of the complex interaction of the front layers and the back layers.

The warp of a substrate can be measured on either side of a line drawn along the surface of the substrate. Warp along a diagonal line is one method employed. Because of process uncertainty, warp of a substrate has a probability distribution rather than a single value. A mean of the probability distribution can then be calculated. Also, the corresponding standard deviation can be calculated.

If laminate theory is applied to the substrate structure, one of ordinary skill in the art can build a thermomechanical model of the substrate. Thermal warp is readily estimated from the thermomechanical model.

The warp of a substrate at room temperature is based on an aggregate of two components: a process induced warp component and thermally induced warp component. The process induced warp component arises from residual stresses built into a substrate during the manufacturing process. The thermally induced warp component arises from thermal contraction from the nominally stress frees state at about 250 degrees C. or the like to the stress induced state of warp at room temperature, upon cooling.

Ideally, the laminated organic substrate has zero warp. However, there is a degree of acceptable warp wherein the substrate need not be discarded. If a substrate has a warp above the limit of acceptable warp, it must be discarded. This increases the cost of manufacturing. The present process reduces the cost of manufacturing by mitigation of thermal warp.

Because the symmetry of the front layers and the back layers cannot be perfectly maintained, specifically under the die footprint, there is always an inherent warp that is unavoidable. The problem of inherent warp increases significantly when complex circuit design and the like are employed.

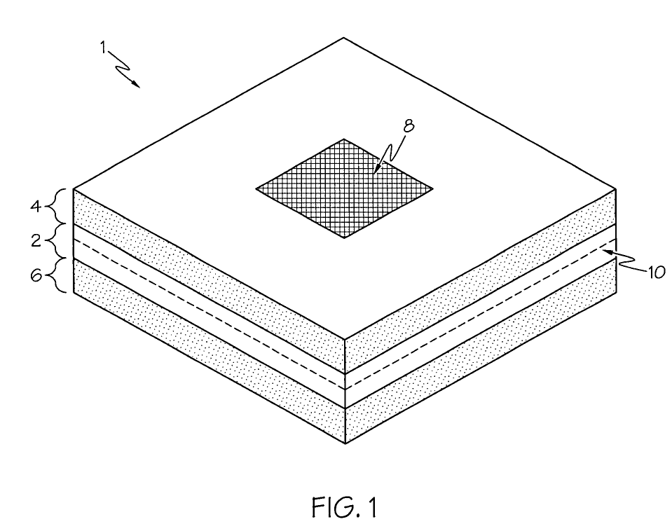

FIG. 1 is a representation of a laminated substrate 1 that includes a plurality of layers. Generally the laminated substrate 1 may include any number of layers. Dielectric layers are disposed on opposite sides of a core layer 2, and conductive layers are disposed on the dielectric layers in an alternating pattern. A series of stacked alternating front layers 4 and a series of stacked alternating back layers 6 are present on either side of the core layer 2. A die footprint 8 is positioned at the center of the laminated substrate 1. A plane of symmetry for the laminated substrate 1 is represented by dashed line 10.

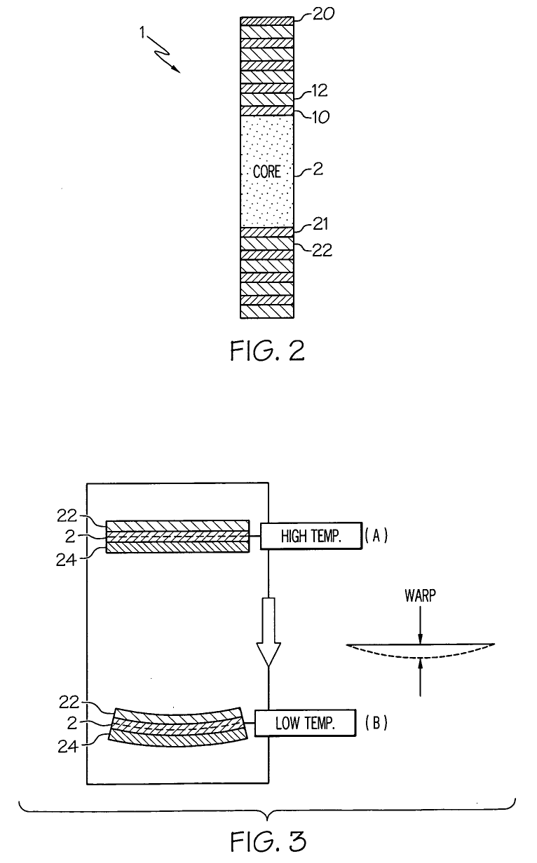

FIG. 2 is a representation of a cross-section of a laminated organic substrate 1 containing circuit carrying layers and dielectric layers. A core layer 2, usually comprising an organic resin such as a polyimide, an epoxy, a polyfluorinated polymer or the like, is positioned in the middle of the laminated organic substrate 1. A solder mask 20 is located on the front side of the core 2, and at the top of the stacked layers of alternating circuit carrying layers and dielectric layers. A first circuit carrying layer 10 is positioned adjacent to the core layer 2 on the front side of laminated substrate 1. A second circuit carrying layer 21 is positioned adjacent to the core layer 2 on the back side of laminated substrate 1. A first dielectric layer 12 is positioned adjacent to the first circuit carrying layer 10. A second dielectric layer 22 is positioned adjacent to the second circuit carrying layer 21. In one embodiment, the dielectric layers comprise a polyimide material. In FIG. 2, four circuit carrying layers are positioned on each side of core layer 2; and four dielectric layers are positioned on each side of said core layer 2. It is within the scope of the present invention to employ a single circuit carrying layer and a single dielectric layer on each side of the core material. In an alternative embodiment, it is within the scope of the present invention to employ a laminated substrate comprising more than four circuit carrying layers and more than four dielectric layers on each side of the core layer.

FIG. 3 is a diagram of the warp mechanism that operates when a bare organic laminated substrate is treated at a high temperature and then cooled to ambient temperature. The core layer 2 is positioned between a front layer 22 and a back layer 24. The front layer 22 has a higher CTE (coefficient of thermal expansion) than the back layer 24. The organic laminated substrate is heated to a high temperature above about 250 degrees C. (A). It is then removed from the heating apparatus and cooled to ambient temperature (B). After cooling, the laminated organic substrate is observed to have substantial warp. The warp is due mainly to the difference in CTE between the front layer and the back layer.

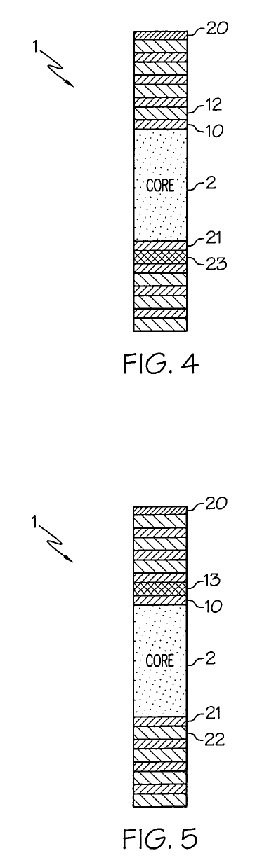

FIG. 4 is a representation of a cross-section of a laminated organic substrate 1 containing circuit carrying layers and dielectric layers. A core layer 2, usually comprising an organic resin such as a polyimide, an epoxy, a polyfluorinated polymer or the like, is positioned in the middle of the laminated organic substrate 1. A solder mask 20 is located on the front side of the core 2, and at the top of the stacked layers of alternating circuit layers and dielectric layers. 2 is a representation of a cross-section of a laminated organic substrate 1 containing circuit carrying layers and dielectric layers. A core layer 2, usually comprising an organic resin such as a polyimide, an epoxy, a polyfluorinated polymer or the like, is positioned in the middle of the laminated organic substrate 1. A solder mask 20 is located on the front side of the core 2, and at the top of the stacked layers of alternating circuit carrying layers and dielectric layers. A first circuit carrying layer 10 is positioned adjacent to the core layer 2 on the front side of laminated substrate 1. A second circuit carrying layer 21 is positioned adjacent to the core layer 2 on the back side of laminated substrate 1. A first dielectric layer 12 is positioned adjacent to the first circuit carrying layer 10. A dielectric bottom layer 23 has been increased in thickness in accordance with the process of the present invention.

FIG. 5 is a representation of a cross-section of a laminated organic substrate 1 containing circuit carrying layers and dielectric layers. A core layer 2, usually comprising an organic resin such as a polyimide, an epoxy, a polyfluorinated polymer or the like, is positioned in the middle of the laminated organic substrate 1. A solder mask 20 is located on the front side of the core 2, and at the top of the stacked layers of alternating circuit layers and dielectric layers. A first circuit carrying layer 10 is positioned adjacent to the core layer 2 on the front side of laminated substrate 1. A second circuit carrying layer 21 is positioned adjacent to the core layer 2 on the back side of laminated substrate 1. A second dielectric layer 22 is positioned adjacent to the second circuit carrying layer 21. A first dielectric layer 13, positioned adjacent to the first circuit carrying layer 10, has been increased in thickness in accordance with the process of the present invention.

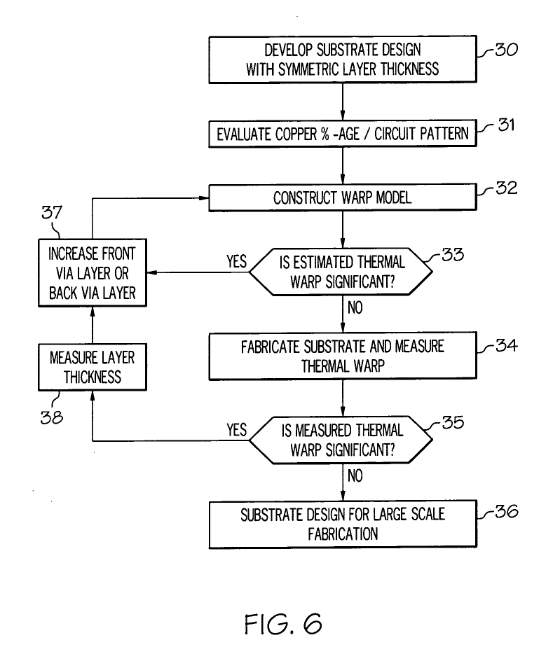

FIG. 6 is a flow chart of the process of the present invention. Conventional board design tools are employed in a step 30 to obtain an organic substrate design comprising a core layer, circuit carrying layers and dielectric layers. Symmetric layer thickness assumptions are employed in the construction. Circuit patterns are provided on the organic substrate. In a step 31 the circuit pattern and the percentage of copper in the circuit patterns are evaluated. In a step 32 an evaluation of circuit pattern and percentage of copper is employed to construct a first thermal warp model of the organic substrate. In a step 33 the first thermal warp model is compared to a model of acceptable thermal warp. The process displayed in the flow chart has reached a first decision junction; which comprises a first query: “is estimated thermal warp significant?” If the answer to the first query is “no”, then the organic substrate design of step 30 is fabricated. In a step 34 the fabricated organic substrate is heated, cooled and measured for thermal warp. The process displayed in the flow chart has reached a second decision junction; which comprises a second query: “is measured thermal warp significant?” If the answer to the second query is “no”, then the fabricated organic substrate is removed to step 36, which represents the end of the substrate design process. Large scale production of the laminated organic substrate can then proceed, without concern for unacceptable amount of warp in said substrate.

Referring to the first decision junction, represented by step 33, which comprises the first query: “is estimated thermal warp significant?”; if the answer is “yes”, then the organic substrate design of step 30 is modified. A modification step 37 comprises increasing the thickness of a dielectric layer of the organic substrate design. The dielectric layer, in one embodiment, is a bottom dielectric layer. The dielectric layer, in another embodiment, is a front dielectric layer. In yet another embodiment, the dielectric layer that is chosen for increased thickness is a bottom layer or a front layer that is closest to the organic core layer of the organic substrate design. After modification of the organic substrate design, the modified design is returned to step 32.

Referring to the second decision junction, represented by step 35, which comprises the second query: “is measured thermal warp significant?”, if the answer is “yes”, then the fabricated organic substrate is removed to step 38 where layer thicknesses are measured. After measurement of the thicknesses of the layers of the fabricated organic substrate, the fabricated substrate is reduced to a computerized model and returned to modification step 37. The process continues until an acceptable warp model is obtained.

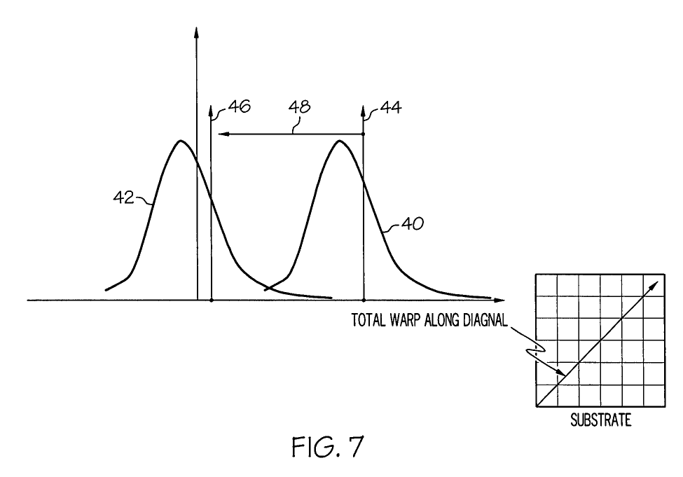

FIG. 7 is a Cartesian diagram showing the mitigation in mean warp of a laminated organic substrate based on implementation of the process of the present invention. The diagram includes a warp distribution curve 40 of a laminated organic substrate based on process uncertainty; and a warp distribution curve 42 of a modified laminated organic substrate, the modification being based on the process of the present invention. The warp distribution curves are based on measurement of warp along a diagonal line drawn across the relevant substrate. Substrates are chosen from a standard laminated organic substrate having symmetrical circuit carrying layers and symmetrical dielectric layers on each side of an organic core layer; and a modified laminated organic substrate having a thickened dielectric layer on either the front side or the back side of said modified substrate. The diagram further includes a mean distribution for each of the warp distribution curves. The mean distribution 44 is calculated from the warp distribution curve 40. The mean distribution 46 is calculated from the warp distribution curve 42. The x-axis of the Cartesian diagram represents the total warp of the laminated organic substrate along a diagonal line drawn across the surface of said substrate. The y-axis of the Cartesian diagram represents the probability of warp. Reduction in mean distribution is represented by line 48 in FIG. 7. This reduction is the direct result of the employment of the process of the present invention.

In the fabrication of a laminated organic substrate, the layers are applied serially such that at first the core layer, dielectric layers and conductive layers are pressed and bonded together. The conductive layers are patterned, and any necessary blind-vias to connect conductive layers are formed before the remaining layers are bonded to the structure. Subsequently, the additional dielectric layers and conductive layers are bonded to the other layers.

Alternatively, several metal/dielectric/metal layers can be simultaneously pressed together, rather than being done in series. Whether done serially or simultaneously, larger or smaller numbers of layers can be employed. Seven and nine layer substrates have many practical applications.

The conductive and dielectric layers are disposed symmetrically about a core layer. Each dielectric or conductive layer formed on one side of a core layer has a corresponding layer of the same material formed on the opposite side of the core layer. Conductive layers are preferably formed from a conductive material, such as copper.

Dielectric layers are preferably made from laminates of high-temperature organic dielectric substrate materials, such as, but not limited to, polyimides and polyimide laminates, epoxy resins, organic materials, or dielectric materials comprised at least in part of polytetrafluoroethylene, with or without a filler. A more detailed description of these materials is provided hereinbelow.

Dielectric layers are formed from an organic substrate material, such as a high-temperature organic dielectric substrate material, to have a thickness of between about 12 micrometers to about 100 micrometers. As a representative example, dielectric layers could have a nominal thickness of about 50 micrometers.

The conductive layers are made of a conductive material, preferably a ½ oz. copper layer having a nominal thickness of 19 micrometers.

The computerized processing unit of the present process converts the respective equivalent physical property values into a simulation file using a data conversion program. It then extracts information on an external shape, a thickness, and a layer structure from the data, and creates simulation shape data based on the extracted information on an external shape, a thickness, and a layer structure. Then, the processing unit executes the warp simulation using the simulation shape data and the simulation file; and outputs a result of execution of the warp simulation. Therefore, it is possible to calculate equivalent physical property values with high reliability with respect to the warp simulation.

Another embodiment of the present invention is a process for predicting the warp of a relatively thin organic substrate; and then preventing the so predicted warp by modification of the thickness of a front layer attached to the core to obtain an organic substrate having asymmetric thickness. In an alternative embodiment, the back layer can be modified, the back layer being also attached to the core on the alternate side of the core. Preferably, the front layer is a front via layer; and the back layer is a back via layer. A via layer comprises a dielectric material having via holes therein. The front via layer is preferably indirectly attached to the core, as a layer of copper circuitry is positioned between the core and the front via layer. The layer of circuitry is called the front circuit layer. The back via layer is preferably indirectly attached to the core, as a layer of copper circuitry, called the back circuit layer, is positioned between the core and the back via layer. It is common to have more than one set of via layers and circuit layers on each side of a core.

Another embodiment of the present invention is a computerized process for preparing an organic substrate having substantially reduced warp. A computer aided design is employed to construct the organic substrate of the present invention, said substrate constructed to undergo negligible warp during thermal treatment process steps. The computer aided design methodology includes developing a substrate design employing conventional board design tools. In this design step, all the layers are of conventional symmetrical thickness. The circuit pattern on the substrate is then evaluated. Copper percentage can also be evaluated. A warp model based on the conventional design thickness is then constructed by the computer. If the estimated thermal warp is not above a first predetermined thermal warp value, then the organic substrate is fabricated. The thermal warp of the substrate is then measured. If the measured thermal warp is not above a second predetermined thermal warp value, then a large scale fabrication process is completed. In one embodiment, the first predetermined thermal warp value can be the same as the second predetermined thermal warp value.

In another embodiment of the present invention, a computerized process for the large scale production of an organic laminated substrate is hereby disclosed. The laminated substrate is susceptible to thermal warp during processing steps. The computerized process comprises constructing an organic laminated substrate comprising an organic core layer having a front surface and a back surface. At least a first circuit carrying layer is constructed on the front surface of the organic core. At least a second circuit carrying layer is constructed on the back surface of the organic core. The first circuit carrying layer and the second circuit carrying layer are substantially symmetrical in thickness. At least a first front dielectric layer is constructed on the first circuit carrying layer. At least a second back dielectric layer is constructed on the second circuit carrying layer. The first front dielectric layer and the second back dielectric layer are substantially symmetrical in thickness. In an embodiment of the present invention, each side of the organic core layer comprises a plurality of circuit carrying layers and dielectric layers in alternating fashion. The process further comprises reducing the organic laminated substrate to a first computer aided design. A first computerized warp model for the first computer aided design is then constructed. The process further comprises measuring thermal warp of the first computerized warp model to obtain a first measurement of thermal warp; and comparing the first measurement of thermal warp to a predetermined measurement of unacceptable thermal warp to obtain a first decision selected from the group consisting of “proceed with fabrication” and “increase thickness of a dielectric layer”. The dielectric layer is a member selected from the group consisting of a front dielectric layer and a back dielectric layer. The process further comprises the step of increasing the thickness of a dielectric layer when the decision is “increase thickness of dielectric layer” to obtain a first computerized model of modified thickness. The process further comprises recycling the first computerized model of modified thickness to the step of constructing, and repeating the recycling step until the decision in the comparing step reads “proceed with fabrication”. The process further comprises fabricating a first fabrication of the laminated organic substrate; measuring thermal warp of the first fabrication of the laminated organic substrate to obtain a second measurement of thermal warp; and evaluating the second measurement of thermal warp with respect to the predetermined measurement of unacceptable thermal warp to obtain a second decision selected from the group consisting of “proceed with large scale production” and “increase thickness of a dielectric layer”. The dielectric layer is a member selected from the group consisting of a front dielectric layer and a back dielectric layer. The process further comprises reducing the first fabrication of the laminated organic substrate to a second computer aided design when the second decision is “increase thickness of dielectric layer”; and increasing the thickness of a dielectric layer of the second computer aided design to obtain a second computerized model of modified thickness. The process further comprises returning the second computerized model of modified thickness to the step of evaluating; and repeating the returning step until the decision in the evaluating step reads “proceed with large scale production”. The laminated organic substrate is then produced on a large scale. The production is based on a computerized model. The computerized model can be the first computer aided design if all of the measurements of warp are within the acceptable range. Otherwise, the computerized model can be either the first computerized model of modified thickness or the second computerized model of modified thickness. The first computerized model of modified thickness can of course be the result of a progression of computerized models. And the second computerized model of modified thickness can also be the result of a progression of computerized models.

In another embodiment of the present invention, an organic laminated substrate prepared according to the process of the present invention is hereby disclosed. The laminated substrate has substantially reduced thermal warp. The process for the production of the organic laminated substrate comprises constructing an organic laminated substrate comprising an organic core layer having a front surface and a back surface. At least a first circuit carrying layer is constructed on the front surface of the organic core. At least a second circuit carrying layer is constructed on the back surface of the organic core. The first circuit carrying layer and the second circuit carrying layer are substantially symmetrical in thickness. At least a first front dielectric layer is constructed on the first circuit carrying layer. At least a second back dielectric layer is constructed on the second circuit carrying layer. The first front dielectric layer and the second back dielectric layer are substantially symmetrical in thickness. In an embodiment of the present invention, each side of the organic core layer comprises a plurality of circuit carrying layers and dielectric layers in alternating fashion. The process further comprises reducing the organic laminated substrate to a first computer aided design. A first computerized warp model for the first computer aided design is then constructed. The process further comprises measuring thermal warp of the first computerized warp model to obtain a first measurement of thermal warp; and comparing the first measurement of thermal warp to a predetermined measurement of unacceptable thermal warp to obtain a first decision selected from the group consisting of “proceed with fabrication” and “increase thickness of a dielectric layer”. The dielectric layer is a member selected from the group consisting of a front dielectric layer and a back dielectric layer. The process further comprises the step of increasing the thickness of a dielectric layer when the decision is “increase thickness of dielectric layer” to obtain a first computerized model of modified thickness. The process further comprises recycling the first computerized model of modified thickness to the step of constructing, and repeating the recycling step until the decision in the comparing step reads “proceed with fabrication”. The process further comprises fabricating a first fabrication of the laminated organic substrate; measuring thermal warp of the first fabrication of the laminated organic substrate to obtain a second measurement of thermal warp; and evaluating the second measurement of thermal warp with respect to the predetermined measurement of unacceptable thermal warp to obtain a second decision selected from the group consisting of “proceed with large scale production” and “increase thickness of a dielectric layer”. The dielectric layer is a member selected from the group consisting of a front dielectric layer and a back dielectric layer. The process further comprises reducing the first fabrication of the laminated organic substrate to a second computer aided design when the second decision is “increase thickness of dielectric layer”; and increasing the thickness of a dielectric layer of the second computer aided design to obtain a second computerized model of modified thickness. The process further comprises returning the second computerized model of modified thickness to the step of evaluating; and repeating the returning step until the decision in the evaluating step reads “proceed with large scale production”. The laminated organic substrate is then produced on a large scale. The production is based on a computerized model. The computerized model can be the first computer aided design if all of the measurements of warp are within the acceptable range. Otherwise, the computerized model can be either the first computerized model of modified thickness or the second computerized model of modified thickness. The first computerized model of modified thickness can of course be the result of a progression of computerized models. And the second computerized model of modified thickness can also be the result of a progression of computerized models.

While the invention has been described by specific embodiments, there is no intent to limit the inventive concept except as set forth in the following claim.

We claim:

1. A computerized process for the large scale production of an organic laminated substrate, the laminated substrate being susceptible to thermal warp; the process comprising:
constructing an organic laminated substrate comprising an organic core having a front surface and a back surface, at least a first circuit carrying layer on the front surface, at least a second circuit carrying layer on the back surface, wherein the first circuit carrying layer and the second circuit carrying layer are substantially symmetrical in thickness, at least a first front dielectric layer on the first circuit carrying layer, and at least a second back dielectric layer on the second circuit carrying layer wherein the first front dielectric layer and the second back dielectric layer are substantially symmetrical in thickness;
reducing the organic laminated substrate to a first computer aided design;
constructing a first computerized warp model for the first computer aided design;
measuring thermal warp of the first computerized warp model to obtain a first measurement of thermal warp;
comparing the first measurement of thermal warp to a predetermined measurement of unacceptable thermal warp to obtain a first decision selected from the group consisting of “proceed with fabrication” and “increase thickness of a dielectric layer”, wherein the dielectric layer is a member selected from the group consisting of a front dielectric layer and a back dielectric layer;
increasing the thickness of the layer when the decision is “increase thickness of dielectric layer” to obtain a first computerized model of modified thickness;
recycling the first computerized model of modified thickness to the step of constructing;
repeating the recycling step until the decision in the comparing step reads “proceed with fabrication”;
fabricating a first fabrication of the laminated organic substrate;
measuring thermal warp of the first fabrication of the laminated organic substrate to obtain a second measurement of thermal warp;
evaluating the second measurement of thermal warp with respect to the predetermined measurement of unacceptable thermal warp to obtain a second decision selected from the group consisting of “proceed with large scale production” and “increase thickness of a dielectric layer”, wherein the dielectric layer is a member selected from the group consisting of a front dielectric layer and a back dielectric layer;
reducing the first fabrication of the laminated organic substrate to a second computer aided design when the second decision is “increase thickness of dielectric layer”;
increasing the thickness of a dielectric layer of the second computer aided design to obtain a second computerized model of modified thickness;
returning the second computerized model of modified thickness to the step of evaluating;
repeating the returning step until the decision in the evaluating step reads “proceed with large scale production”; and
producing the laminated organic substrate on a large scale based on a computerized model wherein the computerized model is a member selected from the group consisting of the first computer aided design, the first computerized model of modified thickness and the second computerized model of modified thickness.
